(19) United States
(12) Patent Application Publication
(10) Pub. No.: US 2013/0073445 A1
(43) Pub. Date: Mar. 21, 2013

(54) Real-Time Approval of Bank Draft Payments for Money Transfer Transactions

(71) Applicant: Richard Meszaros, Bloomington, MN (US)

(72) Inventor: Richard Meszaros, Bloomington, MN (US)

(73) Assignee: Moneygram International, Inc., Minneapolis, MN (US)

(21) Appl. No.: 13/239,324

(22) Filed: Sep. 21, 2011

(51) Int. Cl. G06Q 20/10; G06Q 40/02; G06Q 20/40

(52) U.S. Cl. 705/38; 705/44; 705/40

(57) ABSTRACT

Systems and methods which allow for utilizing bank draft payments to contemporaneously fund money transfer transactions while also mitigating for the risk the bank draft payment being returned are provided. One embodiment provides a method for funding a money transfer transaction. The method includes establishing a money transfer transaction between a sending party and a receiving party. Account information corresponding to an account of the sending party is received and a bank draft transaction from the account may be established. With the account information and optionally other transaction information, a determination is made whether to accept the bank draft transaction to fund the money transfer transaction prior to the clearance of the bank draft transaction. In the event that the bank draft transaction is accepted, the money transfer transaction is funded prior to clearance of the bank draft transaction.

### TECHNICAL FIELD

The present application relates to money transfer transactions, and more specifically to systems and methods for funding money transfer transactions.

### BACKGROUND

Numerous money transfer transactions where a sending party creates a transaction in order to send funds to a receiving party are undertaken on a daily basis. Currently there are various methods utilized to fund a money transfer transaction. The easiest method is where a sender provides cash currency at a money transfer agent location or to a machine belonging to the agent. Additionally, non-cash transactions may be originated and funded either at an agent location or using a machine or online application. One non-cash funding method which has a relatively quick approval turnaround time, and presents very little risk to the money transfer service, is a transaction which is funded by a debit or credit card. For example, with a credit transaction, a money transfer agent may obtain an authorization on that card, similar to how other merchants implement credit card transactions, which provides an assurance that those funds are guaranteed funds. Such an assurance is important to a money transfer service as the funds may be sent any number of places globally in a short amount of time.

While such credit or debit card transactions are convenient, quick, and present minimal risk to the money transfer service company, it is noted that these transactions also have negative aspects. For example, the respective credit companies or banks collect a substantial fee for this service. Such a fee will often be borne by both the money transfer service, customer, or both.

Another method to fund a money transfer transaction is by using a bank draft such as by utilizing an Automated Clearing House (ACH) transaction center. However, in these transactions payment may be returned for a number of reasons (e.g. insufficient funds, and the like) after the money transfer transaction is initiated. Consequently, this payment method is never used to fund an express transaction wherein the funds are available immediately after the send transaction. As such, money transfer services generally do not allow the bank draft or ACH funded money transfer to be completed until after the funds are received from the financial institution so as to avoid the potential risk of not receiving funds. This delay in the completion time for the transaction is inconvenient and even unacceptable in many situations. However, one advantage of a bank draft transaction is that it is significantly lower in terms of cost, thereby decreasing the overall cost of the money transfer transaction.

### BRIEF SUMMARY

The present application provides systems and methods which allow for utilizing bank draft payments, such as an ACH payment, to contemporaneously fund money transfer transactions while also mitigating for the risk the bank draft payment being returned. In accordance with one embodiment, a method for funding a money transfer transaction is provided. The method includes establishing a money transfer transaction between a sending party and a receiving party. In order to fund the money transfer transaction, account information corresponding to an account of the sending party is received and a bank draft transaction from the account may be established. Additional information may be compiled including information regarding account history, account viability, etc. Such information may be derived from one or more sources associated with the money transfer transaction and/or from a third party source. With the information, a determination is made whether to accept the bank draft transaction to fund the money transfer transaction prior to the clearance of the bank draft transaction. In the event that the bank draft transaction is accepted, the money transfer transaction is funded prior to clearance of the bank draft transaction.

In accordance with another embodiment a method for facilitating a financial payment using a bank draft transaction is provided. The method includes receiving account information and an amount of payment to be deducted from an account in a bank draft transaction. Information pertaining to the sender and the sender's account is then compiled in order to make a determination as to whether to accept the bank draft transaction. Additionally, the determination may include a determination as to whether to fund the financial payment prior to clearance of the bank draft transaction.

Another embodiment includes a system for facilitating a money transfer. The system includes a processing device configured to receive information for a money transfer transaction. Additionally, the system includes a decision engine configured to compile the transaction information and information relating to a payment account. The decision engine is configured to analyze information regarding the money transfer transaction and the payment account. The decision engine is further configured to make a determination whether to fund the money transfer transaction prior to the clearance of the funds from the payment account based on the analyzed information. It is noted that embodiments may be implemented by computing devices within an agent location, utilizing applications executed on or from a personal user device and/or using a combination of these devices.

The foregoing has outlined rather broadly the features and technical advantages of the present invention in order that the detailed description that follows may be better understood. Additional features and advantages will be described hereinafter which form the subject of the claims. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of embodiments described herein, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present embodiments.

### BRIEF DESCRIPTION OF THE DRAWINGS

For a more complete understanding, reference is now made to the following descriptions taken in conjunction with the accompanying drawings, in which:

FIG. 1 illustrates a system for facilitating one or more money transfer transactions in accordance with an embodiment of the present application;

FIG. 2 illustrates a flowchart of a method for facilitating a money transfer transaction in accordance with an embodiment of the present application; and

FIG. 3 illustrates a flowchart of a method for facilitating a financial payment using a bank draft transaction in accordance with an embodiment of the present application.

### DETAILED DESCRIPTION

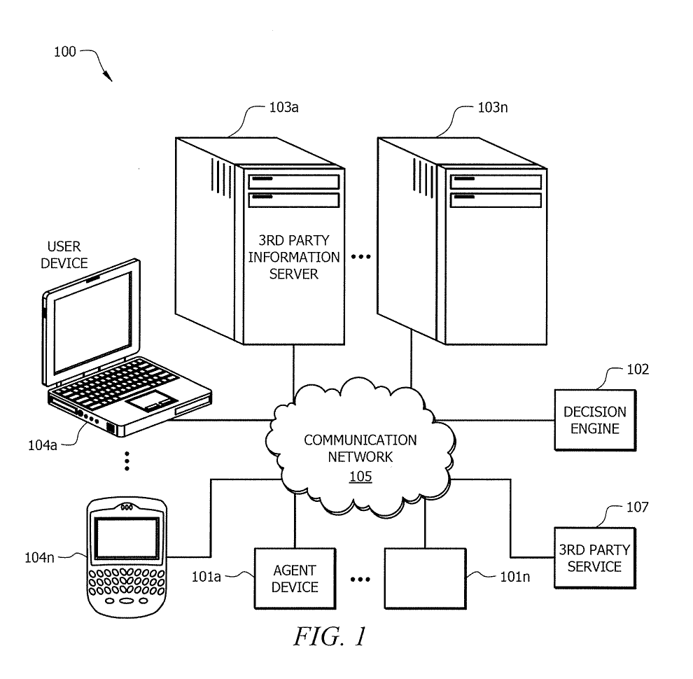

FIG. 1 illustrates a system 100 for facilitating one or more money transfer transactions in accordance with an embodiment of the present application. System 100 includes agent devices 101a-101n, bank draft transaction decision engine 102, third party information databases 103a-103n, and user devices 104a-104n, each in communication with others over communication network 105.

Communications between devices in system 100 may be facilitated in whole, or in part, by communication network 105. Communication network 105 may comprise the Internet, WiFi, mobile communications networks such as GSM, CDMA, 3G/4G, WiMax, LTE, and the like. Further, communications network 105 may comprise a combination of network types working collectively.

Agent devices 101a-101n may correspond to computer systems within a money transfer agent location. Agent devices 101a-101n could include special purpose computers programmed to implement steps described herein, or could be conventional processing devices configured to run software which facilitates the described money transfer transactions. For example, such devices may be computer systems which are accessible by an agent at an agent location, may be automated machines such as an Automated Teller Machine (ATM), and the like. Agent devices 101a-101n may be located throughout the world and one or more devices may be utilized within a single money transfer transaction. Agent devices 101a-101n are configured to send and receive information over communication network 105. In some embodiments, agent devices 101a-101n may also have a direct connection with transaction decision engine 102. Agent devices 101a-101n may be configured to transmit transaction information between respective devices of system 100.

Transaction decision engine 102 may be implemented as a computing device, as a network of computing devices, or in any manner that facilitates one or more of the storage, compilation and communication of transaction decision information within system 100. In some embodiments, transaction decision engine 102 may be distributed among agent locations within agent devices 101a-101n. Transaction decision engine 102 may be configured to compile information from one or more sources regarding a sender and/or the sender's payment method in order to provide a transaction decision regarding the reliability of the sender's payment method. Transaction decision engine 102 may utilize a plurality of sources including information derived from an agent device 101, user device 104, and third party server 103 to generate a transaction decision. Transaction decisions may be based on information regarding the sender's account, the type of transfer being made, the previous transfer history of the sender, or any other information pertinent to the reliability of the sending party.

As noted above, transaction reliability information may be compiled by decision engine 102 utilizing one or more services corresponding to third party transaction reliability database 103. Third party transaction reliability database 103 may correspond to services which report on the validity of a banking account of the sending party, such as TeleCheck and the like. Further, third party transaction reliability database 103 may correspond to credit reporting services such as Equifax, Experian, Transunion, and the like. Information from third party databases may be sent to transaction decision engine 102, or directly to one or more agent devices 101a-101n to assist in facilitating reliability determinations.

In some embodiments, rules may be created within decision engine 102 which correspond to the type of information received from a third party database 103. For example, it may be useful to receive information which indicates whether an account has been opened in the last 90 days, whether there has ever been bad activity on the account, charge-backs, returned checks and the like. Such information may be probative on a money transfer agent's ability to underwrite a payment on the transfer transaction. Additionally, in some embodiments, decision engine 102 may simply receive a score from a third party source which is indicative of an aspect of the transaction. This score may be utilized alone, or with other information to make a reliability determination.

Another example of information which may be derived from a third party database 103 may include utilizing streamlined credit reporting models similar to how utility providers determine whether deposits are required for customers. For example, a rule may be set up within decision engine 102 which utilizes a report that is indicative of whether a customer is reliable up to a small amount (e.g. $100-$200) for payment based on a streamlined credit rating from a credit rating agency.

In some embodiments, decision engine 102 may utilize an overall scoring system to generate a reliability score. In some embodiments, such a reliability score may exclusively take into account information known to the money transfer agent. Additionally, in some embodiments a generated reliability score may also take into account third party reliability information. Furthermore, embodiments may utilize a combination of all sources of information and assign rules as to the specific weight that sources are recognized in order to generate a transaction determination score.

As discussed above, decision engine 102 may take into account multiple types and sources of data to make a determination regarding the reliability of a bank draft transaction. It is further noted that in some embodiments, the types of information and the rules which may surround a limitation may vary between locations and countries for multiple reasons, e.g. banking systems and rules, may create different risk assessment needs, transaction amounts and destinations may create differing hazards to look for, etc. In some embodiments, decision engine 102 maintains a plurality of risk assessment schemas to be utilized when differing situations, transaction types, etc., are utilized.

In another embodiment, transaction decision engine 102 may be utilized to create a scoring system which may be utilized by outside third party service entities 107 for other types of transactions. For example, utility companies, mobile phone providers, payday lending services, and the like may utilize this scoring system which takes into account information regarding the sender and transaction types in order to authorize their respective transactions.

User devices 104a-104n may be any type of device which would facilitate the exchange of information within system 100. For example, client devices may include computer systems, tablet devices, mobile telephones, and the like. Different embodiments may utilize different aspects of the types of client devices. For example, mobile telephones and tablet devices may have the ability to connect with various communications networks and may have different application execution capabilities. User devices 104a-104n may be utilized before, during and after a money transfer transaction in any manner to facilitate convenient and secure transactions.

For example, a user device 104 may be utilized to initiate a transaction and to begin the process of compiling decision information corresponding to the transaction. The initial information may be sent to an agent location to facilitate an expedient transaction, or the transaction may be completely implemented utilizing framework of a user device 104. Further, in some embodiments, applications executed on user devices 104a-104n may initiate money transactions and send the funds with the assistance of one or more of transaction decision engine 102 or an agent device 101.

Further, a user device 104 may be utilized to provide transaction information to a sender or receiver. For example, once a money transfer transaction is initiated, a transaction code may be sent to the sender or receiving party. In the event that the transaction code is sent to the sender, the sender may convey that code to the receiver. Such a transaction code may be utilized by the receiving party to initiate the receipt of the money transfer transaction in order to complete the transaction.

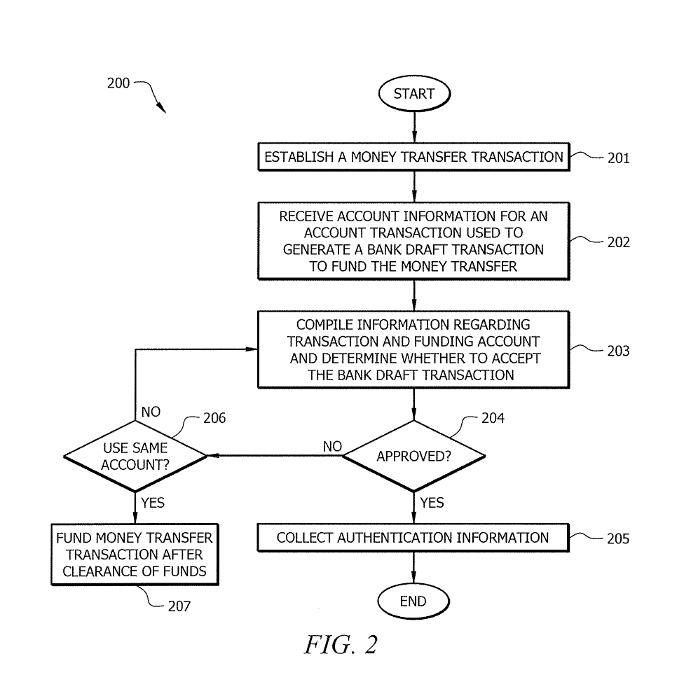

FIG. 2 illustrates a flowchart of a method 200 for facilitating a money transfer transaction in accordance with an embodiment of the present application. Method 200 may be implemented within a system such as system 100 or any other suitable system. Additionally, while method 200 is set forth in steps, it is noted that nothing in this application necessarily limits the order in which the illustrated steps are implemented. In fact, some steps may be implemented in different orders, simultaneously, at multiple points in time, or not at all.

Method 200 begins by establishing a money transfer transaction between a sending party and a receiving party 201. The money transfer transaction may include a typical money transfer transaction such as can be implemented by a money transfer service such as Moneygram International. Additionally, the money transfer transaction may be a bill-pay style transaction. The transaction may be established using an agent device 101 and/or a user device 104 as discussed above with respect to system 100 of FIG. 1.

Account information regarding an account used to generate a bank draft transaction to fund the money transfer transaction is received at step 202. Account information may include any information which would assist in facilitating a bank draft transaction. For example, when the bank draft is in the form of an ACH payment, embodiments would generally receive information such as the account number and the routing number of the bank which administers the account.

At step 203, the information regarding the transaction and/or the account information is utilized to determine whether to accept the bank draft transaction to fund the money transfer transaction prior to clearance of the bank draft transaction. This determination may be made, for example, using decision engine 102 as discussed above with respect to system 100 of FIG. 1. This determination may take into account any number of reliability information. For example, in one embodiment the determination is made while considering information from a third party account verification service. In another embodiment, the determination is made while considering information from a credit reporting service. While in yet another embodiment, the determination may be made while considering transaction history of a user, the type and nature of the transaction, the transaction amount, and the like, or a combination of any of the above.

Additionally, the determination may be made by compiling the above-noted information and generating a score which is associated with one or more of the transaction, the sender, or the sender's funding account. This score may be utilized by a money transfer service to then make the determination regarding the bank draft transaction.

In the event that the account is approved (step 204), e.g. it meets criteria for funding the money transfer transaction prior to actually receiving the funds from the bank draft transaction, the money transfer transaction is funded prior to clearance of the bank draft transaction at step 204. In the event that the account is not approved (step 204), the sender may select whether they want to utilize the non-approved account to fund the money transfer transaction at step 206. If the same account is to be used, the money transfer transaction is placed on hold and is executed upon clearance of the funds from the bank draft transaction at step 207. If the user decides to utilize a different account in order to expedite the transaction, the user may be redirected to provide information for another account at step 202. Further, in some embodiments, a user may select to utilize a different (non-bank draft) payment means such as by utilizing a credit card, making a cash payment, etc.

It is noted that the above method is advantageous over previous types of money transfer funding transactions. The difference in time between funding the transaction at step 205 as opposed to step 207 may at times be on the order of days. As such, utilizing the determination of step 203 allows for an expedited transaction while also mitigating a degree of risk to the money transfer service.

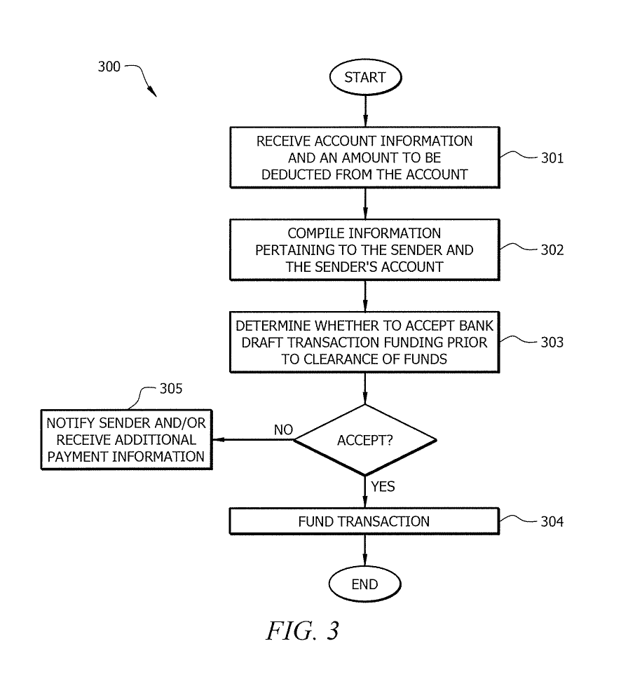

FIG. 3 illustrates a flowchart of a method 300 for facilitating a financial payment using a bank draft transaction in accordance with an embodiment of the present application. As was the case with respect to the flowchart of FIG. 2, method 300 may be implemented within a system such as system 100 or any other suitable system. Additionally, while method 300 is set forth in steps, it is noted that nothing in this application necessarily limits the order in which the illustrated steps are implemented. In fact, some steps may be implemented in different order, simultaneously, at multiple points in time, or not at all.

The method begins by receiving account information and an amount of payment to be deducted from an account in a bank draft transaction 301. As noted above, such information may be provided by a user utilizing a user device such as device 104, at an agent location using an agent device 101, and the like. At step 302, information pertaining to the sender and the sender's account is compiled by a processing device. Such a compilation may be implemented in whole or in part by any number of devices such as described with respect to system 100, e.g. a user device 104, agent device 101, decision engine 102, and the like.

With the compiled information a determination as to whether to accept the bank draft transaction and whether to fund the financial payment prior to clearance of the bank draft transaction is made at step 303. This determination may be implemented as discussed in embodiments above utilizing multiple sources of information and multiple devices to compile the information. If the transaction accelerated funding is accepted, the method then funds the transaction at step 304. In the event that the accelerated transaction funding is declined, the sender is notified at step 305 and additional payment instructions may be received. Additional instructions could include an instruction to complete the financial payment utilizing the bank draft transaction after clearance of the funds. Additionally, these instructions could include the sender providing an additional payment means to fund the financial payment.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method for funding a money transfer transaction, the method comprising:
establishing a money transfer transaction between a sending party and a receiving party;
receiving account information corresponding to an account of the sending party;
determining whether to accept the bank draft transaction to fund the money transfer transaction prior to clearance of the bank draft transaction; and
funding the money transfer transaction prior to clearance of the bank draft transaction based on said determining.

2. The method of claim 1 wherein the bank draft transaction is an Automated Clearing House (ACH) transaction.

3. The method of claim 1 wherein the money transfer transaction comprises a bill-pay transaction.

4. The method of claim 1 wherein said determining comprises consideration of information received from an account verification service.

5. The method of claim 1 wherein said determining comprises consideration of information received from a credit reporting service.

6. The method of claim 1 wherein said determining comprises consideration of the transaction history of the sender.

7. The method of claim 1 wherein said determining comprises consideration of the type of transaction being implemented.

8. The method of claim 1 further comprising generating a score for the transaction to be used in said determining step.

9. The method of claim 8 wherein the score corresponds to a compilation of information regarding the sender, the transaction, and the sender's payment account.

10. A method for facilitating a financial payment using a bank draft transaction, the method comprising:
receiving account information and an amount of payment to be deducted from an account in a bank draft transaction;
compiling, by a processing device, information pertaining to the sender and the sender's account; and
determining whether to accept the bank draft transaction and whether to fund the financial payment prior to clearance of the bank draft transaction based on the compiled information.

11. The method of claim 10 wherein the financial payment is for a money transfer transaction.

12. The method of claim 10 wherein the financial payment is for a bill-pay transaction.

13. The method of claim 10 wherein said compiling information comprises compiling information received from an account verification service.

14. The method of claim 10 wherein said compiling information comprises compiling information received from a credit reporting service.

15. The method of claim 10 wherein said compiling information comprises compiling information regarding the transaction history of the sender.

16. A system for facilitating a money transfer, said system comprising:
a processing device configured to receive information for a money transfer transaction; and
a decision engine configured to compile the transaction information and information relating to a payment account, the decision engine configured to analyze information regarding the money transfer transaction and the payment account, the decision engine further configured to make a determination whether to fund the money transfer transaction prior to the clearance of the funds from the payment account based on the analyzed information.

17. The system of claim 16 wherein transaction information includes information regarding the sender.

18. The system of claim 16 wherein decision engine comprises a plurality of risk assessment rule schemas.

19. The system of claim 18 wherein the plurality of rule schemas include differing considerations based on the location of the money transfer transaction.

20. The system of claim 18 wherein the plurality of rule schemas include differing considerations based on the details of the transaction.

21. The system of claim 20 wherein the details of the transaction includes at least one of the transaction amount and money transfer destination.

22. A computer program product having a computer readable medium with logic incorporated thereon which, when executed, performs the steps of:
establishing a money transfer transaction between a sending party and a receiving party;
receiving account information corresponding to an account of the sending party and establishing a bank draft transaction from the account; and
determining whether to accept the bank draft transaction to fund the money transfer transaction prior to clearance of the bank draft transaction.

23. The computer program product of claim 22 wherein the bank draft transaction is an ACH transaction.

24. The computer program product of claim 22 wherein said determining comprises consideration of information received from an account verification service.

25. The computer program product of claim 22 wherein said determining comprises consideration of information received from a credit reporting service.

26. The computer program product of claim 22 wherein said determining comprises consideration of the transaction history of the sender.
